(19) United States
(12) Patent Application Publication
(10) Pub. No.: US 2011/0080379 A1
(43) Pub. Date: Apr. 7, 2011

(54) DRIVING CIRCUIT

(76) Inventors: Sung-Yau Yeh, Hsinchu County (TW); Wen-Chi Wu, Tao-Yuan City (TW)

(21) Appl. No.: 12/635,647

(22) Filed: Dec. 10, 2009

(30) Foreign Application Priority Data
Oct. 5, 2009 (TW) 098133767

(51) Int. Cl. G09G 5/00; G09G 3/36

(52) U.S. Cl. 345/204; 345/98

(57) ABSTRACT

The present invention provides a driving circuit comprising a first data logic unit, a latch unit, and a determining unit. The first data logic unit is utilized for receiving at least a digital data signal and a first control signal, and for selectively inversing the digital data signal to generate a first digital output data signal according to the first control signal. The latch unit is utilized for receiving the first digital output data signal and a second control signal, and for selectively setting a second digital output data signal whether inversed from the first digital output data signal according to the second control signal. The determining unit is utilized for receiving the digital data signal and determining a transition number of the digital data signal in comparison with a previous digital data signal, and outputting the first control signal and the second control signal according to the transition number.

### BACKGROUND OF THE INVENTION

1. Field of the Invention

The present invention relates to a driving circuit, and more particularly, to a source driving circuit applied to an LCD panel, and the source driving circuit is capable of efficiently reducing power consumption, heat, and electromagnetic interference (EMI).

2. Description of the Prior Art

Please refer to FIG. 1. FIG. 1 shows a simplified block diagram of a conventional source driving circuit 100 applied to an LCD panel in accordance with a prior art. As shown in FIG. 1, the source driving circuit 100 comprises: a data logic unit 102 and a latch unit 104. In the prior art, when the channel number required by the source driving circuit 100 becomes greater, the data signal transmitting path between the data logic unit 102 and the latch unit 104 will become longer, and the loading will become heavier since the RGB data signals are transmitted from the data logic unit 102 to the latch unit 104 continuously. In addition, the required operation frequency becomes higher due to requirements of high resolution and low cost. The above factors lift the operation current, and result in greater power consumption, more heat, and higher electromagnetic interference (EMI) of the source driving circuit 100, and the lifetime of the source driving circuit 100 will be shorter. For example, if the digital data signals received by the first data logic unit 102 are 6-bit RGB data signals, and the RGB data signals are determined separately, then presume the digital data signal S is 111111, and a previous digital data signal is 000000, and thus a transition number of the data signals in the data signal transmitting path between the data logic unit 102 and the latch unit 104 is 6. When the transition number is greater, the source driving circuit 100 will have greater power consumption, more heat, and higher EMI.

### SUMMARY OF THE INVENTION

It is therefore one of the objectives of the present invention to provide a driving circuit capable of efficiently reducing power consumption, heat, and electromagnetic interference (EMI), so as to solve the above problem.

In accordance with an embodiment of the present invention, a driving circuit is disclosed. The driving circuit comprises: a first data logic unit, a latch unit, and a determining unit. The first data logic unit is utilized for receiving at least a N-bit digital data signal and a first control signal, and for selectively inversing the N-bit digital data signal to generate a first digital output data signal according to the first control signal. The latch unit is coupled to the first data logic unit, and utilized for receiving the first digital output data signal and a second control signal, and for selectively setting a second digital output data signal whether inversed from the first digital output data signal or not according to the second control signal. The determining unit is coupled to the first data logic unit and the latch unit, and utilized for receiving the N-bit digital data signal and determining a transition number of the N-bit digital data signal in comparison with a previous N-bit digital data signal, and outputting the first control signal and the second control signal according to the transition number.

In accordance with an embodiment of the present invention, a driving circuit is disclosed. The driving circuit comprises: a first data logic unit, a second data logic unit, a latch unit, a first determining unit, and a second determining unit. The first data logic unit is utilized for receiving at least a N-bit digital data signal and a first control signal, and for selectively inversing the N-bit digital data signal to generate a first digital output data signal according to the first control signal. The second data logic unit is coupled to the first data logic unit, and utilized for receiving the first digital output data signal and a second control signal, and for selectively inversing the first digital output data signal to generate a second digital output data signal according to the second control signal. The latch unit, coupled to the second data logic unit, and utilized for receiving the second digital output data signal and a third control signal, and for selectively setting a third digital output data signal whether inversed from the second digital output data signal or not according to the third control signal. The first determining unit is coupled to the first data logic unit and the latch unit, and utilized for receiving the N-bit digital data signal and determining a transition number of the N-bit digital data signal in comparison with a previous N-bit digital data signal, and outputting the first control signal and a fourth control signal according to the transition number. The second determining unit, is coupled to the second data logic unit, the first determining unit, and the latch unit, and utilized for receiving the N-bit digital data signal and the fourth control signal, and selectively setting the fourth control signal as the third control signal according to the fourth control signal, or determining the transition number of the N-bit digital data signal in comparison with a previous N-bit digital data signal to set the second control signal and the third control signal.

Briefly summarized, the driving circuit disclosed by the present invention is capable of efficiently reducing the transition number of the data signals in the data signal transmitting path between the data logic unit and the latch unit. Thus, the driving circuit disclosed by the present invention is capable of efficiently reducing power consumption, heat, and EMI.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional source driving circuit applied to an LCD panel in accordance with a prior art.

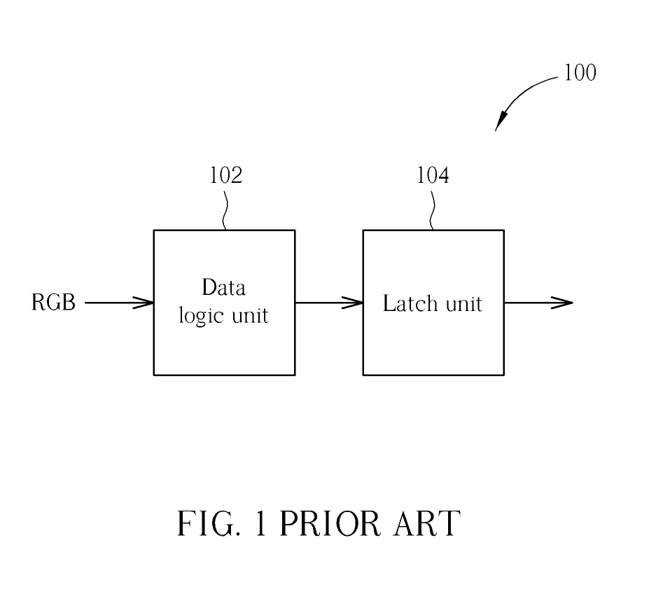

FIG. 2 shows a simplified block diagram of a source driving circuit applied to an LCD panel in accordance with a first embodiment of the present invention.

FIG. 3 shows a simplified block diagram of a source driving circuit applied to an LCD panel in accordance with a second embodiment of the present invention.

FIG. 4 shows a simplified block diagram of a source driving circuit applied to an LCD panel in accordance with a third embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . .” The terms “couple” and “coupled” are intended to mean either an indirect or a direct electrical connection. Thus, if a first device couples to a second device, that connection may be through a direct electrical connection, or through an indirect electrical connection via other devices and connections.

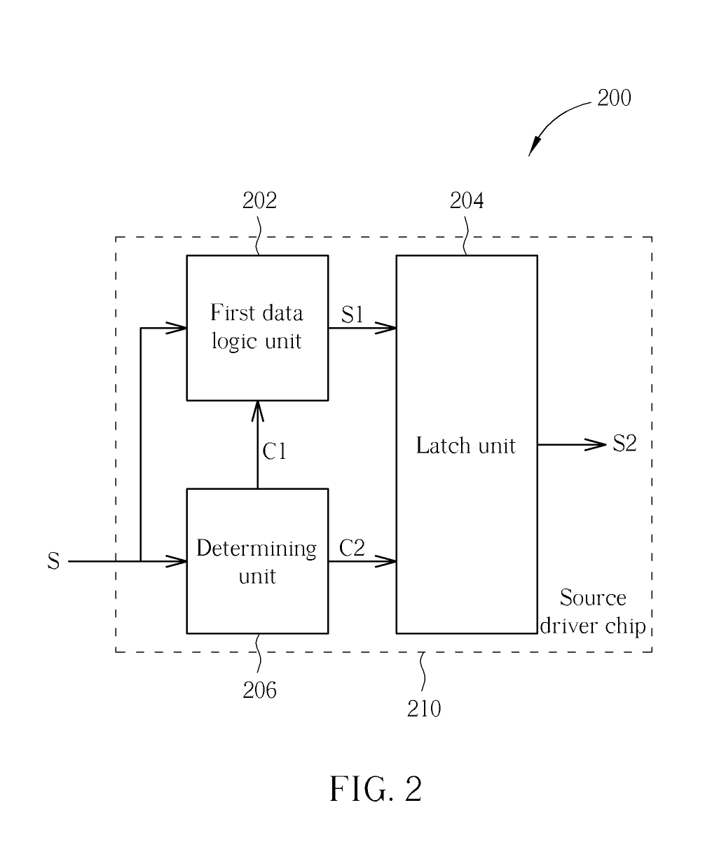

Please refer to FIG. 2. FIG. 2 shows a simplified block diagram of a source driving circuit 200 applied to an LCD panel in accordance with a first embodiment of the present invention. As shown in FIG. 2, the source driving circuit 200 comprises: a first data logic unit 202, a latch unit 204, and a determining unit 206. The first data logic unit 202 is utilized for receiving at least a N-bit digital data signal S and a first control signal C1, and for selectively inversing the N-bit digital data signal S to generate a first digital output data signal S1 according to the first control signal C1. The latch unit 204 is coupled to the first data logic unit 202, and utilized for receiving the first digital output data signal S1 and a second control signal C2, and for selectively setting a second digital output data signal S2 whether inversed from the first digital output data signal S1 or not according to the second control signal C2. The determining unit 206 is coupled to the first data logic unit 202 and the latch unit 204, and utilized for receiving the N-bit digital data signal S and determining a transition number of the N-bit digital data signal S in comparison with a previous N-bit digital data signal, and outputting the first control signal C1 and the second control signal C2 according to the transition number. Please note that the first control signal C1 and the second control signal C2 can be the same logic signals (such as 1), and the first control signal C1 and the second control signal C2 also can be different logic signals (such as 1 and 0).

When the first control signal C1 triggers the first data logic unit 202, the first data logic unit 202 will inverse the N-bit digital data signal S to be the first digital output data signal S1. When the second control signal C2 triggers the latch unit 204, the second digital output data signal S2 outputted by the latch unit 204 is inversed from the first digital output data signal S1. In other words, the N-bit digital data signal S is utilized to be the second digital output data signal S2. When the transition number is greater than N/2, the determining unit 206 will trigger the first control signal C1 and the second control signal C2. In addition, please note that the first data logic unit 202, the latch unit 204, and the determining unit 206 are implemented in a source driver chip 210.

For example, if the digital data signals received by the first data logic unit 202 are 6-bit RGB data signals, and the RGB data signals are determined separately, then presume the digital data signal S is 111100, and a previous digital data signal 110011. Thus, the determining unit 206 determines that a transition number of the digital data signal S in comparison with the previous digital data signal is 4 (that is, greater than 3), and the determining unit 206 will trigger the first control signal C1 and the second control signal C2. When the first control signal C1 triggers the first data logic unit 202, the first data logic unit 202 will inverse the digital data signal S (111100) to be the first digital output data signal S1 (000011). In this way, the transition number of the data signals in the data signal transmitting path between the first data logic unit 202 and the latch unit 204 can be reduced from 4 to 2. When the second control signal C2 triggers the latch unit 204, the second digital output data signal S2 (111100) outputted by the latch unit 204 is inversed from the first digital output data signal S1 (000011). In other words, the digital data signal S (111100) is utilized to be the second digital output data signal S2 (111100); that is, the signal outputted by the latch unit 204 is restored to be the digital data signal S (111100). In addition, if the RGB data signals are determined together, then the digital data signals received by the first data logic unit 202 will become 18-bit RGB data signals. In other words, when the determining unit 206 determines that a transition number of the digital data signal S in comparison with the previous digital data signal is greater than 9, the determining unit 206 will trigger the first control signal C1 and the second control signal.

In this way, a total transition number of the data signals in the data signal transmitting path between the first data logic unit 202 and the latch unit 204 can be reduced, and thus the source driving circuit 200 disclosed by the present invention is capable of efficiently reducing power consumption, heat, and electromagnetic interference (EMI). In addition, if the digital data signals received by the first data logic unit 202 are 6-bit, 2-bus (i.e. 2 pixels) RGB data signals, and the RGB data signals are determined separately, then the source driver chip 210 will have 36 signal lines utilized for transmitting the RGB data signals and 6 signal lines utilized for transmitting the first control signal C1 and the second control signal. If the RGB data signals are determined together, then the source driver chip 210 will have 36 signal lines utilized for transmitting the RGB data signals and 1 signal line utilized for transmitting the first control signal C1 and the second control signal. Herein, please note that the above embodiment is only for an illustrative purpose and is not meant to be a limitation of the present invention. For example, the bit number and bus number of the above RGB data signals can be changed in accordance with different design requirements.

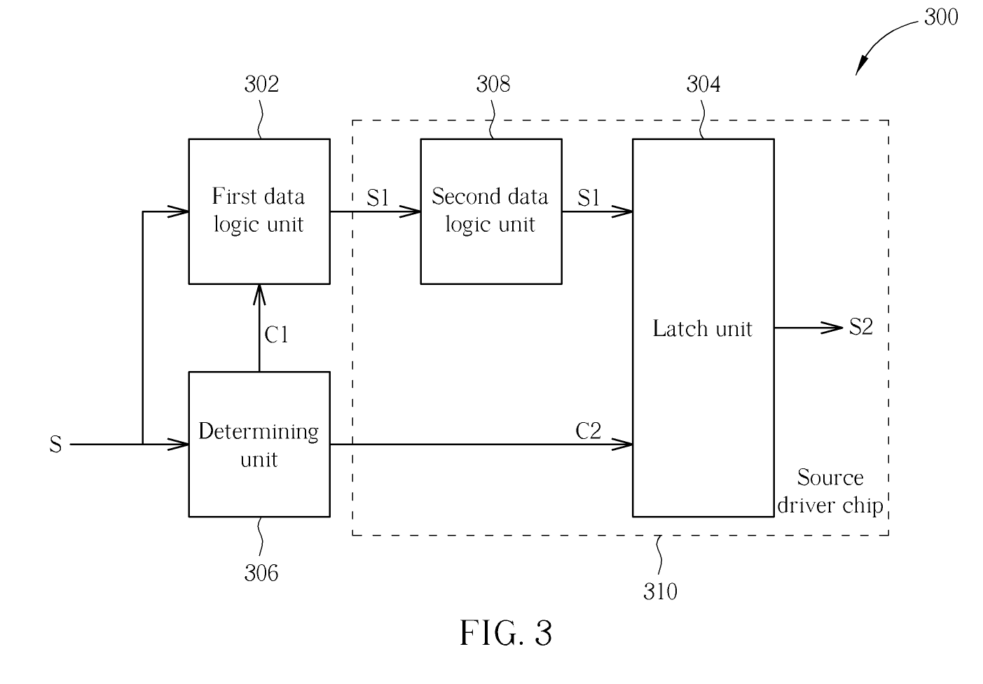

Please refer to FIG. 3. FIG. 3 shows a simplified block diagram of a source driving circuit 300 applied to an LCD panel in accordance with a second embodiment of the present invention. As shown in FIG. 3, the source driving circuit 300 comprises: a first data logic unit 302, a latch unit 304, a determining unit 306, and a second data logic unit 308. The first data logic unit 302 is utilized for receiving at least a N-bit digital data signal S and a first control signal C1, and for selectively inversing the N-bit digital data signal S to generate a first digital output data signal S1 according to the first control signal C1. The latch unit 304 is coupled to the first data logic unit 302, and utilized for receiving the first digital output data signal S1 and a second control signal C2, and for selectively setting a second digital output data signal S2 whether inversed from the first digital output data signal S1 or not according to the second control signal C2. The determining unit 306 is coupled to the first data logic unit 302 and the latch unit 304, and utilized for receiving the N-bit digital data signal S and determining a transition number of the N-bit digital data signal S in comparison with a previous N-bit digital data signal, and outputting the first control signal C1 and the second control signal C2 according to the transition number. Please note that the first control signal C1 and the second control signal C2 can be the same logic signals (such as 1), and the first control signal C1 and the second control signal C2 also can be different logic signals (such as 1 and 0). The second data logic unit 308 is coupled between the first data logic unit 302 and the latch unit 304, and utilized for receiving the first digital output data signal S1 and outputting the first digital output data signal S1.

When the first control signal C1 triggers the first data logic unit 302, the first data logic unit 302 will inverse the N-bit digital data signal S to be the first digital output data signal S1. When the second control signal C2 triggers the latch unit 304, the second digital output data signal S2 outputted by the latch unit 304 is inversed from the first digital output data signal S1. In other words, the N-bit digital data signal S is utilized to be the second digital output data signal S2. When the transition number is greater than N/2, the determining unit 306 will trigger the first control signal C1 and the second control signal C2. In addition, please note that the second data logic unit 308 and the latch unit 304 are implemented in a source driver chip 310, and the first data logic unit 302 and the determining unit 306 are externally connected to the source driver chip 310.

For example, if the digital data signals received by the first data logic unit 302 are 6-bit RGB data signals, and the RGB data signals are determined separately, then presume the digital data signal S is 111100, and a previous digital data signal 110011. Thus, the determining unit 306 determines that a transition number of the digital data signal S in comparison with the previous digital data signal is 4 (that is, greater than 3), and the determining unit 306 will trigger the first control signal C1 and the second control signal C2. When the first control signal C1 triggers the first data logic unit 302, the first data logic unit 302 will inverse the digital data signal S (111100) to be the first digital output data signal S1 (000011) and output the first digital output data signal S1 (000011) to the second data logic unit 308, and the second data logic unit 308 will output the first digital output data signal S1 (000011) to the latch unit 304. In this way, the transition number of the data signals in the data signal transmitting path between the first data logic unit 302 and the latch unit 304 can be reduced from 4 to 2. When the second control signal C2 triggers the latch unit 304, the second digital output data signal S2 (111100) outputted by the latch unit 304 is inversed from the first digital output data signal S1 (000011). In other words, the digital data signal S (111100) is utilized to be the second digital output data signal S2 (111100); that is, the signal outputted by the latch unit 304 is restored to be the digital data signal S (111100). In addition, if the RGB data signals are determined together, then the digital data signals received by the first data logic unit 302 will become 18-bit RGB data signals. In other words, when the determining unit 306 determines that a transition number of the digital data signal S in comparison with the previous digital data signal is greater than 9, the determining unit 306 will trigger the first control signal C1 and the second control signal.

In this way, a total transition number of the data signals in the data signal transmitting path between the second data logic unit 308 and the latch unit 304 can be reduced, and thus the source driving circuit 300 disclosed by the present invention is capable of efficiently reducing power consumption, heat, and electromagnetic interference (EMI). In addition, if the digital data signals received by the first data logic unit 302 are 6-bit, 2-bus (i.e. 2 pixels) RGB data signals, and the RGB data signals are determined separately, then the source driver chip 310 will have 36 signal lines utilized for transmitting the RGB data signals and 6 signal lines utilized for transmitting the first control signal C1 and the second control signal. If the RGB data signals are determined together, then the source driver chip 310 will have 36 signal lines utilized for transmitting the RGB data signals and 1 signal line utilized for transmitting the first control signal C1 and the second control signal. Herein, please note that the above embodiment is only for an illustrative purpose and is not meant to be a limitation of the present invention. For example, the bit number and bus number of the above RGB data signals can be changed in accordance with different design requirements.

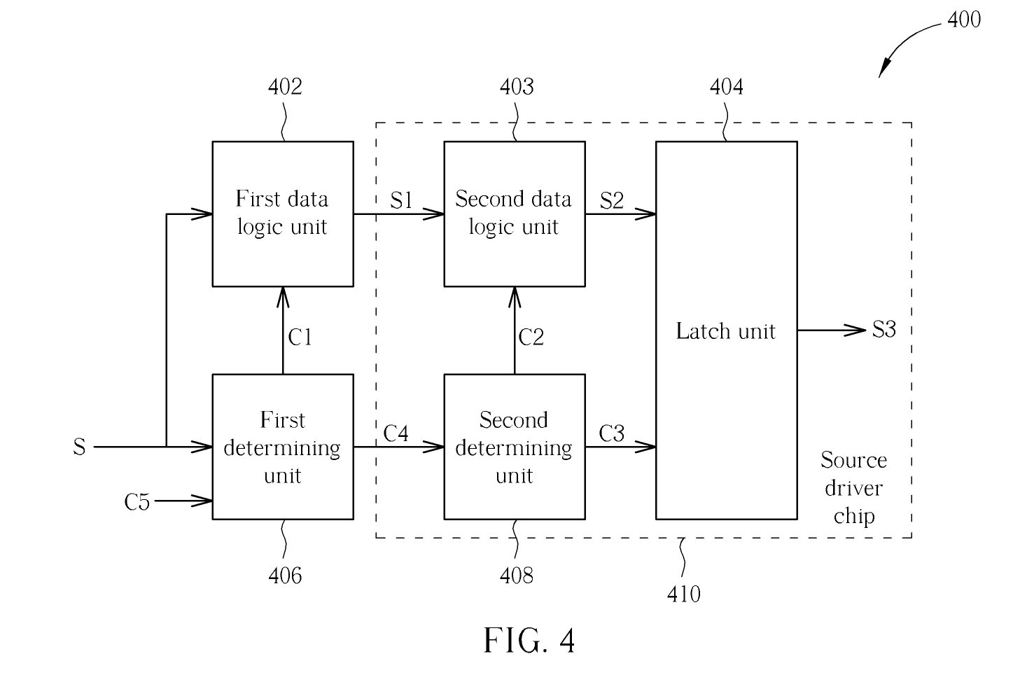

Please refer to FIG. 4. FIG. 4 shows a simplified block diagram of a source driving circuit 400 applied to an LCD panel in accordance with a third embodiment of the present invention. As shown in FIG. 4, the source driving circuit 400 comprises: a first data logic unit 402, a second data logic unit 403, a latch unit 404, a first determining unit 406, and a second determining unit 408. Please note that the second data logic unit 403, the latch unit 404, and the second determining unit 408 are implemented in a source driver chip 410, and the source driver chip 410 is the same as the source driver chip 210 in the first embodiment of the present invention, and thus further explanation of the details and operations of the source driver chip 410 are omitted herein for the sake of brevity. In this embodiment, the first data logic unit 402 and the first determining unit 406 are externally connected to the source driver chip 410, and the first data logic unit 402 and the first determining unit 406 have the same functions as the first data logic unit 302 and the first determining unit 306 in the second embodiment of the present invention. Thus, in the source driving circuit 400, it is practical to choose to use the second data logic unit 403 and the second determining unit 408 in the source driver chip 410 to perform the same operation mentioned in the first embodiment of the present invention, or to use the first data logic unit 402 and the first determining unit 406 externally connected to the source driver chip 410 perform the same operation mentioned in the second embodiment of the present invention. Similarly, the source driving circuit 400 is also capable of efficiently reducing a total transition number of the data signals in the data signal transmitting path between the second data logic unit 403 and the latch unit 404, and thus the source driving circuit 400 disclosed by the present invention is capable of efficiently reducing power consumption, heat, and electromagnetic interference (EMI).

For example, The first data logic unit 402 is utilized for receiving at least a N-bit digital data signal S and a first control signal C1, and for selectively inversing the N-bit digital data signal S to generate a first digital output data signal S1 according to the first control signal C1. The second data logic unit 403 is coupled to the first data logic unit 402, and utilized for receiving the first digital output data signal S1 and a second control signal C2, and for selectively inversing the first digital output data signal S1 to generate a second digital output data signal S2 according to the second control signal C2. The latch unit 404 is coupled to the first data logic unit 402, and utilized for receiving the first digital output data signal S1 and a third control signal C3, and for selectively setting a third digital output data signal S3 whether inversed from the second digital output data signal S2 or not according to the third control signal C3. The first determining unit 406 is coupled to the first data logic unit 402 and the latch unit 404, and utilized for receiving the N-bit digital data signal S and determining a transition number of the N-bit digital data signal S in comparison with a previous N-bit digital data signal, and outputting the first control signal C1 and the fourth control signal C4 according to the transition number. Please note that the first control signal C1 and the fourth control signal C4 can be the same logic signals (such as 1), and the first control signal C1 and the fourth control signal C4 also can be different logic signals (such as 1 and 0). The second determining unit 408 is coupled to the second data logic unit 403, the first determining unit 406, and the latch unit 404, and utilized for receiving the N-bit digital data signal S and the fourth control signal C4, and selectively setting the fourth control signal C4 as the third control signal C3 according to the fourth control signal C4, or determining the transition number of the N-bit digital data signal in comparison with a previous N-bit digital data signal to set the second control signal C2 and the third control signal C3. Please note that the second control signal C2 and the third control signal C3 can be the same logic signals (such as 1), and the second control signal C2 and the third control signal C3 also can be different logic signals (such as 1 and 0).

When the first control signal C1 triggers the first data logic unit 402, the first data logic unit 402 will inverse the N-bit digital data signal S to be the first digital output data signal S1. When the second control signal C2 triggers the second data logic unit 403, the second data logic unit 403 will inverse the first digital output data signal S1 to be the second digital output data signal S2. When the third control signal C3 triggers the latch unit 404, the third digital output data signal S3 outputted by the latch unit 404 will be inversed from the second digital output data signal S2. When the first determining unit 406 determines that the transition number is greater than N/2, the first determining unit 406 will trigger the first control signal C1 and the fourth control signal C4, and the fourth control signal C4 will trigger the second determining unit 408 to set the fourth control signal C4 as the third control signal C3. When the first determining unit 406 determines that the transition number is not greater than N/2, the latch unit 404 will not be triggered by the third control signal C3. In addition, the first determining unit 406 can further receive a fifth control signal C5, and is selectively enabled or disabled according to the fifth control signal C5. When the first determining unit 406 is disabled according to the fifth control signal C5, the second determining unit 408 can be utilized for determining the transition number of the N-bit digital data signal in comparison with a previous N-bit digital data signal to set the second control signal C2 and the third control signal C3.

Briefly summarized, the driving circuit disclosed by the present invention is capable of efficiently reducing the transition number of the data signals in the data signal transmitting path between the data logic unit and the latch unit. Thus, the driving circuit disclosed by the present invention is capable of efficiently reducing power consumption, heat, and electromagnetic interference (EMI).

Those skilled in the art will readily observe that numerous modifications and alterations of the device and method may be made while retaining the teachings of the invention.

What is claimed is:

1. A driving circuit, comprising:
a first data logic unit, for receiving at least a N-bit digital data signal and a first control signal, and for selectively inversing the N-bit digital data signal to generate a first digital output data signal according to the first control signal;
a latch unit, coupled to the first data logic unit, for receiving the first digital output data signal and a second control signal, and for selectively setting a second digital output data signal whether inversed from the first digital output data signal or not according to the second control signal; and
a determining unit, coupled to the first data logic unit and the latch unit, for receiving the N-bit digital data signal and determining a transition number of the N-bit digital data signal in comparison with a previous N-bit digital data signal, and outputting the first control signal and the second control signal according to the transition number.

2. The driving circuit of claim 1, wherein when the first control signal triggers the first data logic unit, the first data logic unit inverses the N-bit digital data signal to be the first digital output data signal; when the second control signal triggers the latch unit, the second digital output data signal outputted by the latch unit is inversed from the first digital output data signal; and when the transition number is greater than N/2, the determining unit triggers the first control signal and the second control signal.

3. The driving circuit of claim 1, wherein the first data logic unit, the latch unit, and the determining unit are implemented in a source driver chip applied to an LCD panel.

4. The driving circuit of claim 1, further comprising:
a second data logic unit, coupled between the first data logic unit and the latch unit, for receiving the first digital output data signal and outputting the first digital output data signal;
wherein the second data logic unit and the latch unit are implemented in a source driver chip applied to an LCD panel, and the first data logic unit and the determining unit are externally connected to the source driver chip.

5. The driving circuit of claim 1, wherein the first control signal and the second control signal are the same logic signals.

6. The driving circuit of claim 1, wherein the first control signal and the second control signal are different logic signals.

7. A driving circuit, comprising:
a first data logic unit, for receiving at least a N-bit digital data signal and a first control signal, and for selectively inversing the N-bit digital data signal to generate a first digital output data signal according to the first control signal;
a second data logic unit, coupled to the first data logic unit, for receiving the first digital output data signal and a second control signal, and for selectively inversing the first digital output data signal to generate a second digital output data signal according to the second control signal;
a latch unit, coupled to the second data logic unit, for receiving the second digital output data signal and a third control signal, and for selectively setting a third digital output data signal whether inversed from the second digital output data signal or not according to the third control signal;
a first determining unit, coupled to the first data logic unit and the latch unit, for receiving the N-bit digital data signal and determining a transition number of the N-bit digital data signal in comparison with a previous N-bit digital data signal, and outputting the first control signal and a fourth control signal according to the transition number; and
a second determining unit, coupled to the second data logic unit, the first determining unit, and the latch unit, for receiving the N-bit digital data signal and the fourth control signal, and selectively setting the fourth control signal as the third control signal according to the fourth control signal, or determining the transition number of the N-bit digital data signal in comparison with a previous N-bit digital data signal to set the second control signal and the third control signal.

8. The driving circuit of claim 7, wherein when the first control signal triggers the first data logic unit, the first data logic unit inverses the N-bit digital data signal to be the first digital output data signal; when the second control signal triggers the second data logic unit, the second data logic unit inverses the first digital output data signal to be the second digital output data signal; when the third control signal triggers the latch unit, the third digital output data signal outputted by the latch unit is inversed from the second digital output data signal; when the first determining unit determines that the transition number is greater than N/2, the first determining unit triggers the first control signal and the fourth control signal, and the fourth control signal triggers the second determining unit to set the fourth control signal as the third control signal; and when the first determining unit determines that the transition number is not greater than N/2, the latch unit is not triggered by the third control signal.

9. The driving circuit of claim 7, wherein the first determining unit further receives a fifth control signal, and is selectively enabled or disabled according to the fifth control signal.

10. The driving circuit of claim 7, wherein the second data logic unit, the latch unit, and the second determining unit are implemented in a source driver chip applied to an LCD panel, and the first data logic unit and the first determining unit are externally connected to the source driver chip.

11. The driving circuit of claim 7, wherein the first control signal and the fourth control signal are the same logic signals.

12. The driving circuit of claim 7, wherein the first control signal and the fourth control signal are different logic signals.

13. The driving circuit of claim 7, wherein the second control signal and the third control signal are the same logic signals.

14. The driving circuit of claim 7, wherein the second control signal and the third control signal are different logic signals.
